(19) United States
(12) Patent Application Publication
(10) Pub. No.: US 2026/0187116 A1
(43) Pub. Date: Jul. 2, 2026

(54) SYSTEM AND METHOD FOR CONVERSATION WITH AN AI COMPANION

(71) Applicant: EVERFRIENDS.AI INC., Grand Rapids, MI (US)

(72) Inventor: Daniel Hungerford, Grand Rapids, MI (US)

(73) Assignee: EVERFRIENDS.AI INC., Grand Rapids, MI (US)

(21) Appl. No.: 19/437,232

(22) Filed: Dec. 30, 2025

Related U.S. Application Data
(60) Provisional application No. 63/739,791, filed on Dec. 30, 2024.

(51) Int. Cl. G06F 16/3329; G06N 5/04

(52) U.S. Cl. CPC G06F 16/33295; G06N 5/04

(57) ABSTRACT

A system and method for facilitating a collaborative conversation with an AI companion are provided. The system utilizes artificial intelligence and machine learning to monitor end user well-being, provide reminders for routine activities, provide real-time notifications to facilitators, and facilitate simulated social interactions with an AI companion. The system comprises a computing device, a server platform, and at an Application Programming Interface (API), configured to facilitate communication between the computing device and the server platform. The server platform houses a knowledge base and a learning language model. Information and conversational prompts are received from the end user via the computing device and relayed via the API to the server platform and processed by the learning language model with reference to the knowledge base, such that a response is formulated by the learning language module and transmitted from the server platform to the end user via the API and computing device.

### CROSS REFERENCE TO RELATED APPLICATIONS

This application claims the benefit of U.S. Provisional Application No. 63/739,791, filed on Dec. 30, 2024, which is hereby incorporated by reference in its entirety.

### TECHNICAL FIELD

The disclosure relates generally to collaborative Artificial Intelligence (AI), computing, and automated natural language conversation. More particularly, the disclosure relates to a system and method for facilitating a collaborative conversation with an Artificial Intelligence (AI) companion.

### BACKGROUND

The field of Artificial Intelligence (AI) continues to pursue an ideal of simulated human behavior that is indistinguishable from real human behavior using natural language. Accordingly, the field has sought better solutions to the problem of automated and semi-automated conversation.

Chatbots have been developed to play the role of a party to a conversation with a human (or humans) in many disciplines. A variety of programmed algorithms and human-created content have been developed to enable respective chatbots to maintain a human-like conversation. The sophistication of chatbot implementations ranges from simple declarative programs to elaborately trained neural networks. Such chatbots of various sophistication may be used in a variety of interactive forums. Conversational AI chatbots are built upon Natural Language Understanding (NLU), Natural Language Processing (NLP), and Machine Learning that enable the same to understand, learn from, and respond in a fashion that mimics human conversation. The distinction between a traditional chatbot and a conversational AI chatbot is in the ability of the conversational AI chatbot to grasp context, manage complex and nuanced conversations, and adapt its responses over time based on the data it accumulates from its interactions with human users.

### SUMMARY

Social isolation is an existing social problem, particularly for the elderly. Studies show that one in four adults over the age of 65 years are considered socially isolated. Such social isolation and related loneliness can lead to increased risk of dementia in these older adults, but regular social interaction has been shown to decrease dementia risk by a substantial percentage. As such, there is a need to address such social isolation and related loneliness for the elderly and other socially isolated individuals, as well as a need to assist the family members and caregivers of such individuals in monitoring and ensuring the physical and mental well-being of such individuals via a solution that is personalized and readily available.

Accordingly, a system and method for facilitating a collaborative conversation with an Artificial Intelligence (AI) companion are provided. The system utilizes artificial intelligence and machine learning technologies to monitor end user (elderly patient) behavior and well-being, provide content recommendations, provide reminders for daily activities, provide real time alerts and SOS notifications to facilitators (family members or caregivers), and facilitate meaningful conversations and simulated social interactions with an AI companion that can read and interpret emotion from the end user.

In short, the present disclosure enables a socially isolated human participant or end user to engage in simulated social interaction with a personalized and empathetic collaborative AI companion, wherein the AI companion is collaborative in that the same is equipped to provide conversational prompts and responses to situational human reconveyances in such human-AI hybrid social conversation, and further enables facilitators to monitor the end user's activity and engagement with the system in order to monitor and evaluate the physical and mental well-being of the end user.

The system comprises a system server platform, a computing device, and at least one Application Programming Interface (API) configured to connect the computing device and the system server platform.

The system server platform comprises a computer readable memory and a first processor configured to execute a set of computer executable instructions. Written on the computer readable memory of the system server platform is at least one storage database, a knowledge base including foundation models, and at least one algorithm or learning language model. The storage database may include a content hub for information including end user (elderly) information, facilitator (family members and caregivers) information, as well as external content delivered via customized interfaces for each of end-users (elderly patient), facilitators (family members), and master administrators. The knowledge base may comprise initial base information related to a conversational language from known sources, information from the storage database about the end user (elderly patient), information from the storage database about the facilitators (family member of end users) and may be updated to include additional learned knowledge about the respective end user through use of the application, e.g., stored logs of prior chat history, calendar appointments, logged activities, and/or other personal information.

The computing device may comprise a mobile device, tablet, virtual reality (VR) or augmented reality (AR) headset, holographic display hardware, computer or other computing device having a computer readable memory and a second processor configured to execute a set of computer executable instructions. The at least one Application Programming Interface (API) may be written on the non-transitory computer readable medium of the computing device and is configured to connect, i.e., allow communication between the computing device and system server platform. The first and second processors are configured to receive information or prompts from the API and execute computer executable instructions that allow for interactive conversation between an end user and an AI companion powered by the knowledge base and at least one algorithm or learning language model housed on the system server platform.

The present method for facilitating a collaborative conversation with an Artificial Intelligence (AI) companion generally comprises the following steps: compiling an end user profile from a plurality of end user inputs, receiving a request to initiate a conversation with the AI companion, receiving a conversational prompt from the end user via the computing device, transmitting the conversational prompt from the computing device to the system server platform via the API, storing the conversational prompt in the knowledge base, evaluating the conversational prompt via the learning language model with reference to the knowledge base and the storage database and formulating a response, transmitting the response from the system server platform to the computing device via the API for delivery to the end user via the AI companion having personalized or end user selected avatar characteristics.

Notably the steps of receiving a conversational prompt via from the end user via the computing device, transmitting the conversational prompt from the computing device to the system server platform via the API, storing the conversational prompt in the knowledge base, evaluating the conversational prompt via the learning language model with reference to the knowledge base and the storage database and formulating a response, transmitting the response from the system server platform to the computing device via the API for delivery to the end user can be iteratively completed throughout a duration of the respective simulated social interaction or conversation.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The operation of the invention may be better understood by reference to the detailed description taken in connection with the following illustrations, wherein:

FIG. 1 is a schematic block diagram of an example system for facilitating a collaborative conversation with an Artificial Intelligence (AI) companion;

FIG. 2 is an example flow chart detailing the steps and sub-steps of the present method;

FIG. 3 is an example user interface related to a time-limited initial trial chat.

FIG. 4 is an example user interface related to registering an account.

FIG. 5 is an example user interface related to step 101 of the present method (compiling an end user profile), particularly sub-step 201, i.e., receiving a plurality of end user inputs, wherein the input is end user or member bibliographic information.

FIG. 6 is a first example user interface related to step 101 of the present method, particularly sub-step 201 receiving a plurality of end user inputs, wherein the input is answers to a plurality of inquiries compiled in an introductory questionnaire about the end user with a free form option;

FIGS. 7A-7C contain a second example user interface related to step 101 of the present method, particularly sub-step 201 receiving a plurality of end user inputs, wherein the input is answers to a plurality of inquiries compiled in an introductory questionnaire about the end user;

FIG. 8 is an example user interface related to step 101 of the present method, particularly sub-step 201 receiving a plurality of end user inputs, wherein the input is event reminders for habitual events of the end user;

FIG. 9 is an example user interface related to step 101 of the present method, particularly sub-step 201 receiving a plurality of end user inputs, wherein the input is emergency contact information for one or more facilitators;

FIG. 10 is an example user interface related to step 101 of the present method, particularly sub-step 201 receiving a plurality of end user inputs, wherein the input is selected alerts related to end user behavior;

FIG. 11 is an example user interface related to step 101 of the present method, particularly sub-step 201 receiving a plurality of end user inputs, wherein the input is selected avatar characteristics of the AI companion;

FIG. 12 is an example user interface related to a user dashboard, from which the end user may edit the user inputs entered in step 101 of the present method, evaluate use of the system 11, select or change a subscription plan, or initiate a conversation with the AI companion via toggling the “Start Chat” or “Chat” button within the interface;

FIG. 13 is an example user interface, from which the end user may select or change a subscription plan;

FIG. 14 is an example user interface related to iteratively repeating steps 103-107 of the present method, wherein a conversational prompt is submitted by the end user and a reply received by the end user from the AI companion.

### DETAILED DESCRIPTION

While the present disclosure may be described with respect to specific applications or industries, those skilled in the art will recognize the broader applicability of the disclosure. The terms “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second” are illustrative only and are not intended to limit the scope of the disclosure in any way.

The term “longitudinal”, as used throughout this detailed description and in the claims, refers to a direction extending a length of a component. In some cases, a component may be identified with a longitudinal axis as well as a forward and rearward longitudinal direction along that axis. The longitudinal direction or axis may also be referred to as an anterior-posterior direction or axis.

The term “transverse”, as used throughout this detailed description and in the claims, refers to a direction extending a width of a component. The transverse direction or axis may also be referred to as a lateral direction or axis or a mediolateral direction or axis.

The term “vertical”, as used throughout this detailed description and in the claims, refers to a direction generally perpendicular to both the lateral and longitudinal directions.

In addition, the term “proximal” refers to a direction that is nearer a center of a component. Likewise, the term “distal” refers to a relative position that is further away from a center of the component. Thus, the terms proximal and distal may be understood to provide generally opposing terms to describe relative spatial positions.

A “human”, in the context of the present invention, is a human being; in particular, an intelligent human mind.

AI refers to artificial intelligence, e.g., the AI companion is not human, but rather a silicon-based system with a neural network, conversation transformer or expert system, or other chatbot technique, which includes collaborative elements. Said another way, AI describes an artificial intelligence, which is defined as an intelligence demonstrated by machines. In this disclosure, the terms AI, chatbot, and bot are used interchangeably. “Bots” or “chatbots” are independent AIs that conduct a conversation with other bots and/or humans.

Natural Languages include evolved and evolving informal and human-comprehensible languages. Natural languages include speech, pronunciation, tenor, gesture, somatic cues, and emotional responses; written communications; multimodal communications such as AR/VR interfaces including sound, odor, taste, touch and vision; human common languages; amongst other human-comprehensible languages. Natural languages are distinct from fixed computer protocols and non-evolving languages.

A “conversation” is a series of conversation segments in any media between participants and is further defined as an exchange of natural language, data and/or information between two or more participants that adheres to linguistic rules for syntax and semantics such as informality, ambiguity, extension, evolution, self-reference, and contradiction. The exchange of data/information segments may include human, other natural language, and machine data. More specifically, a chatbot conversation is a structured set of live and reconveyed human-comprehensible conversation segments, in any media, between participants.

A “prompt” is a conversation segment placed in a forum by a participant and to which participants may respond with a “response”. Collaborative conversation “prompt response” goals may include to propose, posit, probe, inform, entertain, team build, reduce confusion, etc. Prompt response determination methods include analyzing a prompt for similarities with libraries of conversations, experience, experience chains and sensory data, and determining and responding to types of behavior and personality styles. Behavior and personality control mechanisms may be part of a user interface in which they are adjusted to correlate with desired presentation, personality style, and outcomes. A response may be any conversational response, such as a natural language response, a written response, a graphic response (emoji or the like), etc. A prompt or a response may be compound, encompassing multiple adjacent sentences or other communications.

Referring to the drawings, wherein like reference numerals refer to like components throughout the several views, a system 11 and method 100 for facilitating a collaborative conversation with an Artificial Intelligence (AI) companion are provided. While the system 11 and method 100 disclosed herein for facilitating a collaborative conversation with an Artificial Intelligence (AI) companion is generally described as used to monitor and provide companionship for socially isolated and elderly individuals, it will be appreciated that the systems and methods described herein may be used in conjunction with the facilitation of collaborative conversation with an Artificial Intelligence (AI) companion in any context.

In a general sense, the system 11 and method 100 are configured to utilize artificial intelligence and machine learning technologies to monitor end user (elderly patient) behavior and well-being, provide content recommendations, provide reminders for daily activities, provide real time alerts and SOS notifications to facilitators (family members or caregivers), and facilitate meaningful conversations and simulated social interactions with an AI companion. In short, the present disclosure enables a socially isolated human participant or end user to engage in simulated social interaction with a personalized and empathetic collaborative AI companion, wherein the AI companion is collaborative in that the same is equipped to provide conversational prompts and responses to situational human reconveyances in such human-AI hybrid social conversation, and further enables facilitators to monitor the end user's activity and engagement with the system 11 in order to monitor and evaluate the physical and mental well-being of the end user.

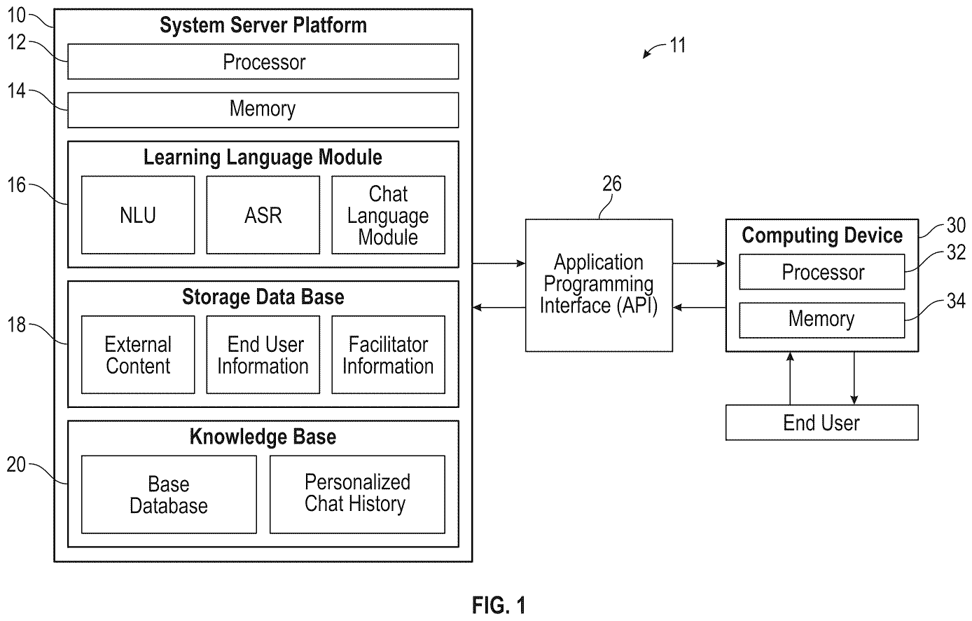

More particularly, Referring to FIG. 1, the system 11 comprises a system server platform 10, a computing device 30, and at least one Application Programming Interface (API) 26 configured to connect the computing device 30 and the system server platform 10.

The system server platform 10 comprises a computer readable memory 14 and a first processor 12 configured to execute a set of computer executable instructions. Written on the computer readable memory 14 of the system server platform 10 is at least one storage database 18, a knowledge base 20 including foundation models, and at least one learning language module 16. The system server platform 10 may also include a variety of other modules written or stored within the computer readable memory 14. As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions.

The computing device 30 may comprise a mobile device, tablet, virtual reality (VR) or augmented reality (AR) headset, holographic display hardware, or computer or other computing device. The computing device 30, irrespective of physical form, has a computer readable memory 34 and a second processor 32 configured to execute a set of computer executable instructions. The at least one Application Programming Interface (API) 26 may be written on the non-transitory computer readable medium 34 of the computing device 30 and is configured to connect, i.e., allow communication between, the computing device 30 to the system server platform 10. The first and second processors 12, 32 may be configured to receive information or prompts from the at least one API 26 and execute computer executable instructions embodied or written on the memory 14, 34 that allows for interactive conversation between an end user and an AI companion powered by the knowledge base 20 and at least one Learning Language Module 16 housed on the system server platform 10.

The computer readable memory 14 of the system server platform 10 and the computer readable memory 34 of the computing device 30 may each be non-transitory computer readable medium. The term non-transitory computer readable medium 14, 34 may include any medium that participates in providing data (e.g., instructions), which may be read by a computer or computing device. Such a medium may take many forms, including, but not limited to, non-volatile media, volatile media, etc. Non-volatile media includes, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, and Solid-State Drive (SSD), a RAM, a PROM, an EPROM, a FLASH-EEPROM, any other memory chip or cartridge, or any other medium from which a computer or computing device can read, as well as networked versions of the same. The non-transitory computer readable mediums 14, 34 store or have written or embodied thereon computer executable instructions that comprise the present method 100 facilitating a collaborative conversation with an Artificial Intelligence (AI) companion.

The system server platform 10 may further include a storage database 18, a knowledge base 20, and a learning language module 16 written on and stored to the non-transitory computer readable medium 14. Databases or data stores described herein may include various kinds of mechanisms for storing, accessing, and retrieving various kinds of data, including a hierarchical database, a set of files in a file system, an application database in a proprietary format, object-relational database management system (ORDMBS), a relational database management system (RDBMS), a non-relational database management system, a look-up table, etc. The storage database 18 is configured to store a compilation of targeted information, including but not limited to end user (elderly patient) information, and facilitator (family member or caregiver) information, and curated external content relevant to the end user compiled from numerous third-party sources. The storage database 18 may compile external content from designated sources direct upload or via an automated information gathering device programmed to retrieve information from the predefined source locations.

The storage database 18 external or third-party content may be populated in part by automated information gathering device such as content crawlers. The content crawlers may comprise internet bots that are configured to seek out targeted information and retrieve the information to be organized and processed. The content crawlers may be specifically configured to seek out content from designated sources. For example, each content crawler may be programed or configured to seek out and retrieve information from a specific predetermined or preprogrammed source. The content crawler may further be programmed or configured to retrieve relevant data for the end user based on other known parameters of the end user.

The storage database 18 may also include end user information and facilitator (family member or caregiver) information that is derived from a variety of user inputs during the process of registering an account or creating a member profile as further detailed herein with respect to method step 101. Such user inputs may comprise, but are not limited to, end user bibliographic information, facilitator bibliographic information, end user emergency contact information, answers to an introductory questionnaire about the end user, selected alerts related to end user behavior, reminders for habitual events of the end user, and selected avatar characteristics of the end user's AI companion. Additional end user information may be retrieved, and stored in the storage database 18, via the use of dynamic forms, which may include links via API to password protected personal information that the end user may need readily available or accessible.

The Learning Language Module 16 is the electronic or technological interpreter of natural language, thereby allowing prompts from the end user to be translated and analyzed and responses formed in natural language. The Learning Language Module 16 may comprise multiple algorithms or programs such as automatic speech recognition (ASR), Natural Language Understanding (NLU), Natural Language Processing (NLP), and a Chat Language Module or chat history providing for end user syntax, inflection, and emotion. In one example embodiment, the learning language module 16 comprises, but is not limited exclusively to, commercially available technology from companies such as Hume.ai and Verne.ai that include emotion detection.

The knowledge base 20 written on and stored to the non-transitory computer readable medium 14 contains known information from the storage database 18 as well as additional learned information from the end user. The knowledge base 20 may comprise initial base information related to a conversational language from known sources, information from the storage database 18 about the end user, information from the storage database 18 about the facilitators (family member of end users), information loaded or obtained via dynamic forms, and may be updated to include additional learned knowledge about the respective end user through use of the application, e.g., stored logs of prior chat history, use of dynamic forms, integrated event calendars, etc. Said another way, the knowledge base 20 is a comprehensive repository of information made up of a variety of stored content.

In one example embodiment, the storage database 18 and the knowledge base 20 are each part of an object-relational database management system (ORDMBS), that has relational capabilities and an object-oriented design akin to commercially available databases such as PostgreSQL, Oracle Database, and IBM Db2.

The system server platform 10 and the computing device 30 may each further comprise at least one processor 12, 32 configured to execute the computer executable instructions 100 embodied on the non-transitory computer readable medium 14, 34 and conveyed between the system server platform 10 and the computing device 30 by the API 26. Computer-executable instructions may be compiled or interpreted from computer programs, software code, or algorithms created using a variety of programming languages and/or technologies, including, without limitation, and either alone or in combination, Java™, C, C++, Visual Basic, JavaScript, Perl, HTML, Python, and Julia, etc. In general, a processor 14 (e.g., a microprocessor) receives instructions, e.g., from a memory or a computer-readable medium, etc. 14, 34, and executes these instructions, thereby performing one or more processes, including one or more of the processes described within the present method 100. Such instructions and other data may be stored using a variety of computer-readable media 14, 34 and transmitted via the at least one API. It is appreciated that software modules can be callable from other modules or from themselves, and/or can be invoked in response to detected events or interrupts. The modules, computer executable instructions, and/or computing device functionality described herein are preferably implemented as software modules but can be represented in hardware or firmware. Generally, the modules, computer executable instructions, and/or computing device functionality described herein refer to logical modules that can be combined with other modules or divided into sub-modules despite their physical organization or storage.

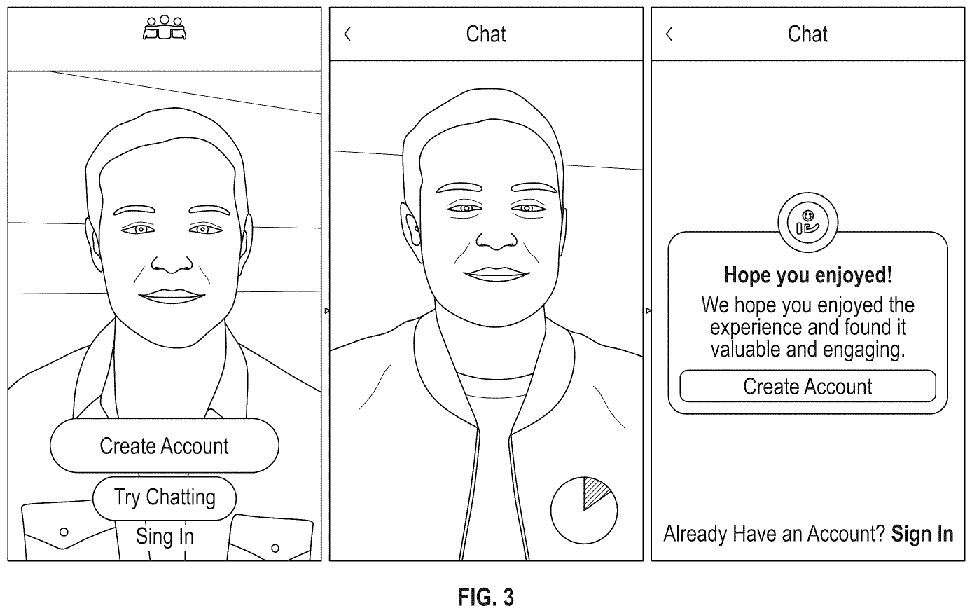

One or more user interface modules, as shown in FIGS. 3-14, may be operative to implement a graphical user interface that can be stored on the system server platform 10 as executable software codes that are transmitted by the API 26 and executed by the one or more computing devices 30. This and other modules can include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

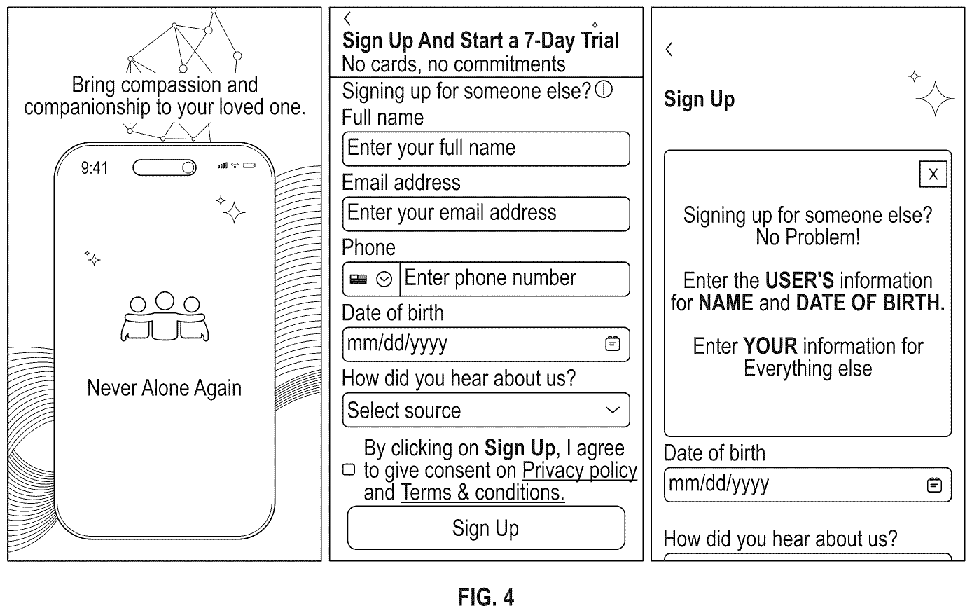

Referring to FIG. 1, an example schematic system diagram is generally provided. The system 11 may populate the storage database 18 using content crawlers that seek out available third-party curated content and the like as well as intake and compile user input information such as end user bibliographic information, facilitator bibliographic information, end user emergency contact information, answers to an introductory questionnaires about the end user, inputs received on dynamic forms, selected alerts related to end user behavior, reminders for habitual events of the end user, end user calendar data, and selected avatar characteristics of the end user's AI companion (collection process via computing device 30 shown in FIGS. 4-11).

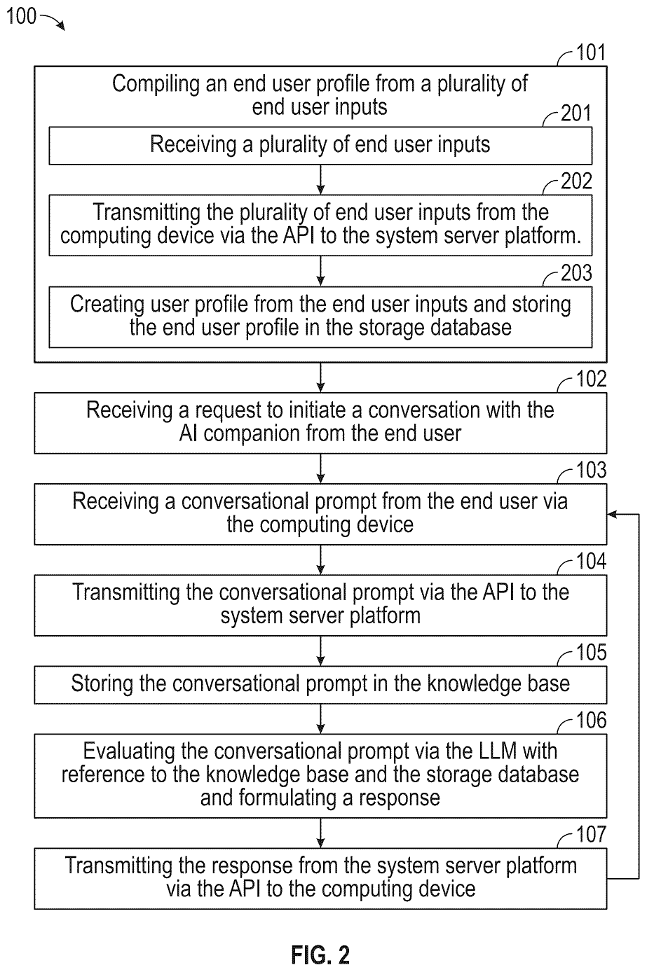

As detailed herein, the processor 12 of the system server platform 10 and the processor 32 of the computing device 30 are configured to execute the computer executable instructions embodied in the respective non-transitory computer readable medium 14, 34, such that the non-transitory computer readable medium 14, 34 is configured to instruct the processor 12, 32 to execute the present method 100. The present method for facilitating a collaborative conversation with an Artificial Intelligence (AI) companion is detailed further in FIG. 2 and comprises several steps 101-107 and sub-steps 201-203. Related representative user interfaces shown on the computing device 30 at each step of the present method 100 are shown in FIGS. 4-14.

Referring to FIG. 3, the end user may, optionally, before creating an account or formally adding any information into the storage module 18 or knowledge database 16, elect to complete an initial trial of the system 11 by initiating an initial dialogue with an example Artificial Intelligence (AI) companion. This initial trial is time limited for the purposes of engaging with the system and an Artificial Intelligence (AI) companion. In one example embodiment, this time limit is approximately two (2) minutes and is tracked via a visual countdown graphic 50 on the interface displayed via the computing device 30. In this initial dialogue, the system 11 operates in the same fashion by executing the present method 100, as detailed in steps 102-107 of the present method detailed further hereinbelow.

Referring to FIG. 4, an example user interface related to registering an end user account. This interface is essentially the end user's and/or facilitators'first interaction with the computer program or software application via the computing device 30. This interface facilitates the building and registration of a user account wherein minimal user information is captured by the system 11 as input by the end user or facilitator creating login and password credentials.

Once an end user account with proper login and password credentials is created, the present method 100 begins at step 101 with the compilation of an end user profile via plurality of end user inputs as shown in FIG. 2 and FIGS. 5-11. More particularly, step 101, compilation of an end user profile via a plurality of end user inputs, is comprised of a plurality of sub-steps 201-203.

First at step 201, the end user provides a plurality of end user inputs to the system 11 via the computing device 30. The end user inputs may be entered via answering structured questionnaire inquiries, filling dynamic forms, or through a continued question and answer phase of an initial trial chat with an example Artificial Intelligence (AI) companion.

Such end user inputs may comprise, but are not limited to end user bibliographic information, including but not limited to name, age, contact details and related contacts or friends (caregivers or family members), and the user's medical condition (if any), facilitator bibliographic information, including but not limited to name, age, contact details, end user emergency contact information, selected alerts related to end user behavior, calendar events of end user, reminders for habitual events of the end user, selected avatar characteristics of the end user's AI companion, and other introductory information that will enable the system 10 to populate the knowledge base 16 with end user details and information.

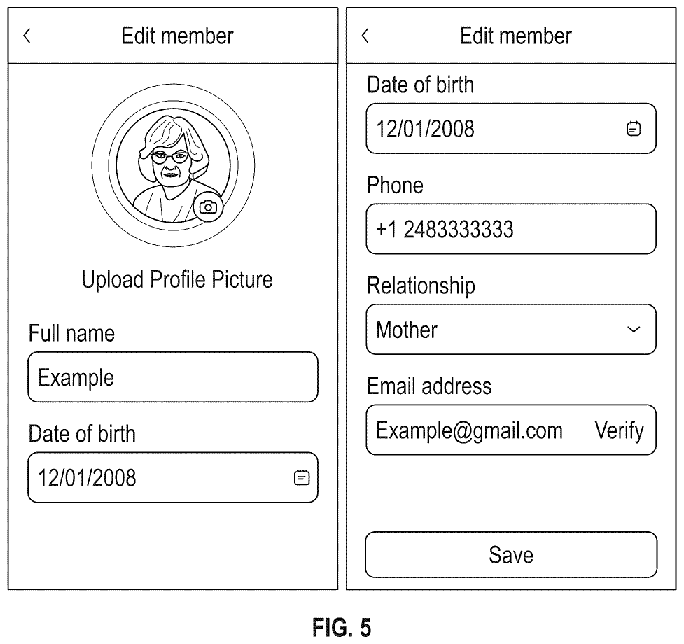

Examples of end user inputs are detailed via the graphical user interfaces displayed in FIGS. 5-11. As detailed via an example user interface shown in FIG. 5, the end user or facilitator may provide end user bibliographic information, including but not limited to name, age, contact details and related contacts or friends (caregivers or family members) and facilitator bibliographic information, including but not limited to name, age, contact details, end user emergency contact information. Such inputs may be entered as shown via answering structured questionnaire inquiries, or alternatively by filling dynamic forms or through a continued question and answer phase of an initial trial chat with an example Artificial Intelligence (AI) companion.

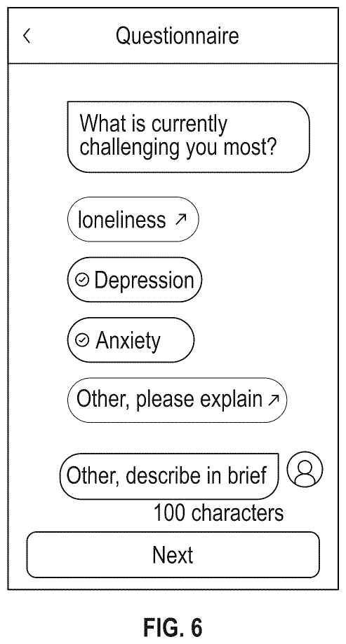

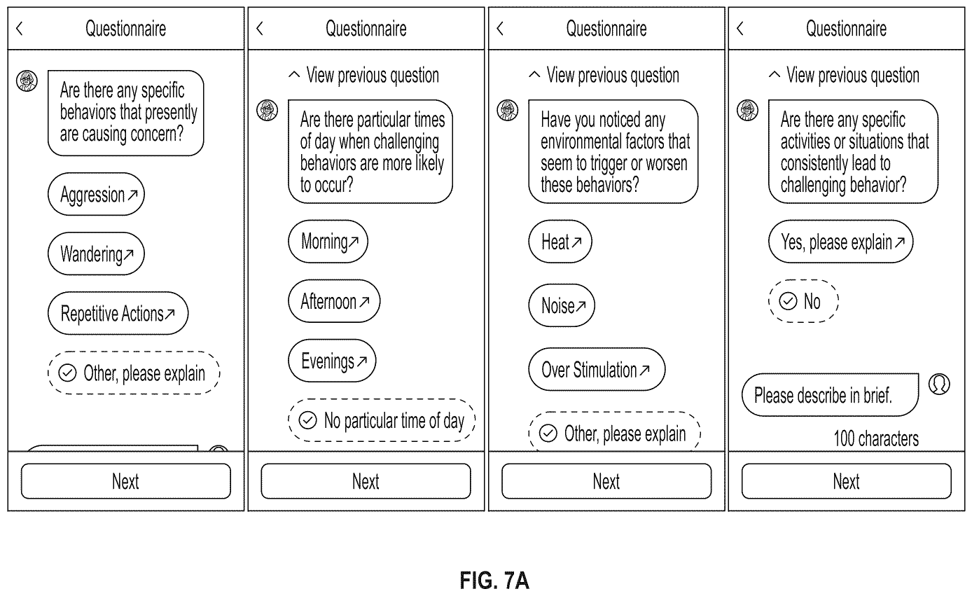

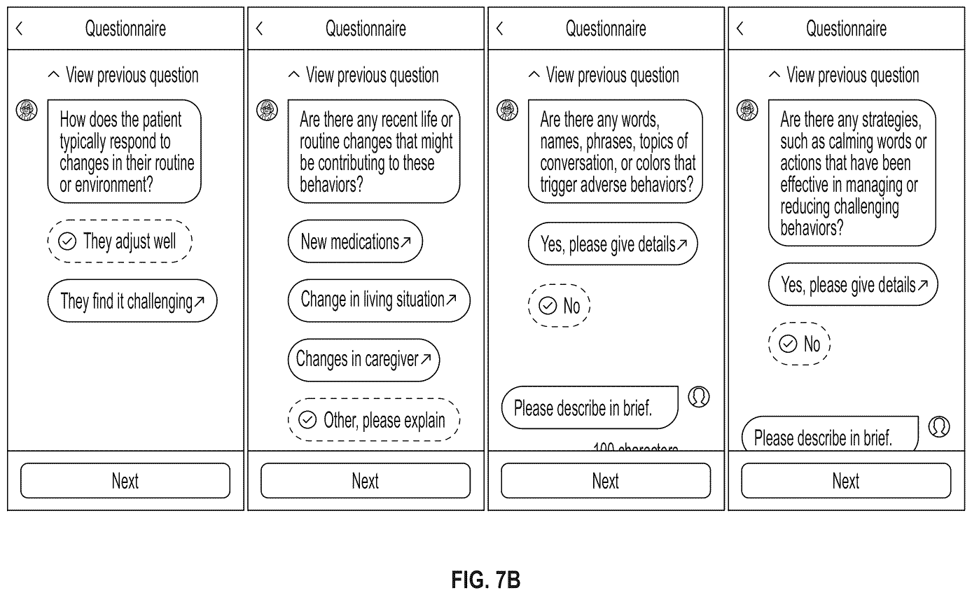

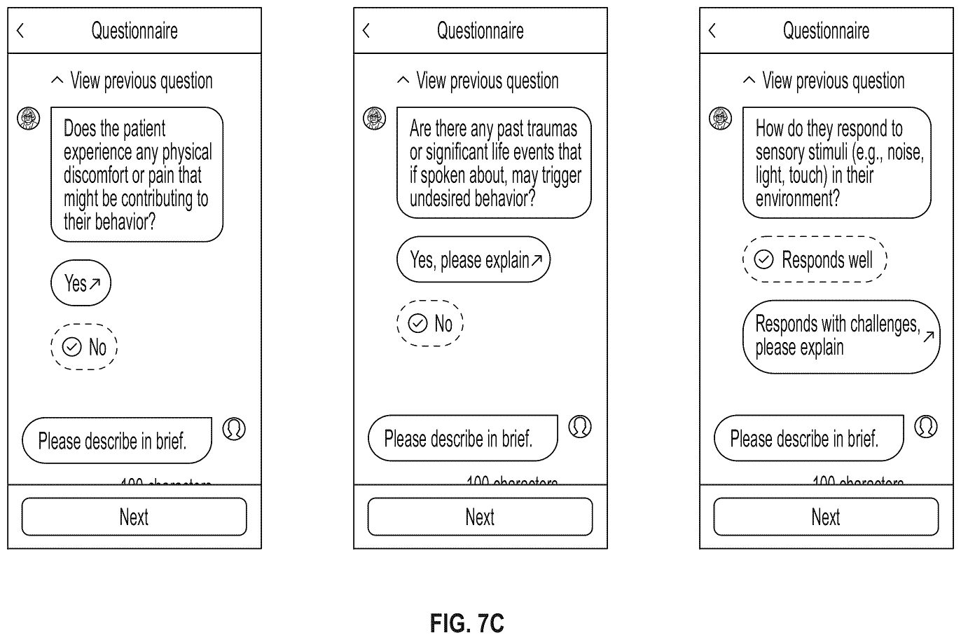

As detailed via an example user interface in FIGS. 6 and 7A-7C, the end user or facilitator is prompted to answer a mental wellness questionnaire, either via standard input field, dynamic form, or continued question and answer phase of an initial trial chat with an example Artificial Intelligence (AI) companion. The mental wellness questionnaire, irrespective of how administered, comprises a series of general questions to assess the mental wellness of the end user to further build out or compile the end user profile to be stored on the storage database 18 and incorporated into the knowledge base 20. Such general questions may include, but are not limited to, for example, specific behavioral concerns, recent life events, traumas, or other situational triggers that if broached in simulated AI conversation would induce a negative response or behaviors in the end user.

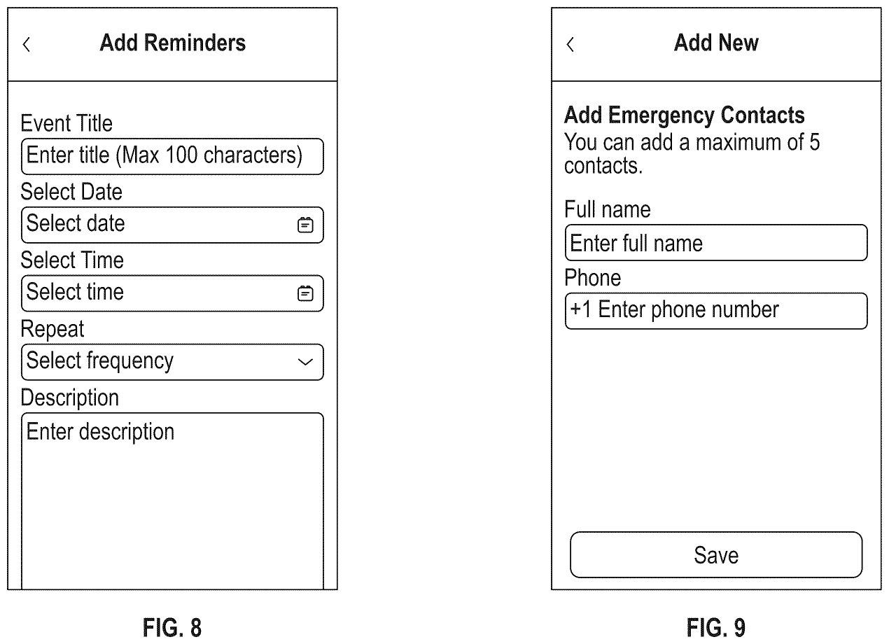

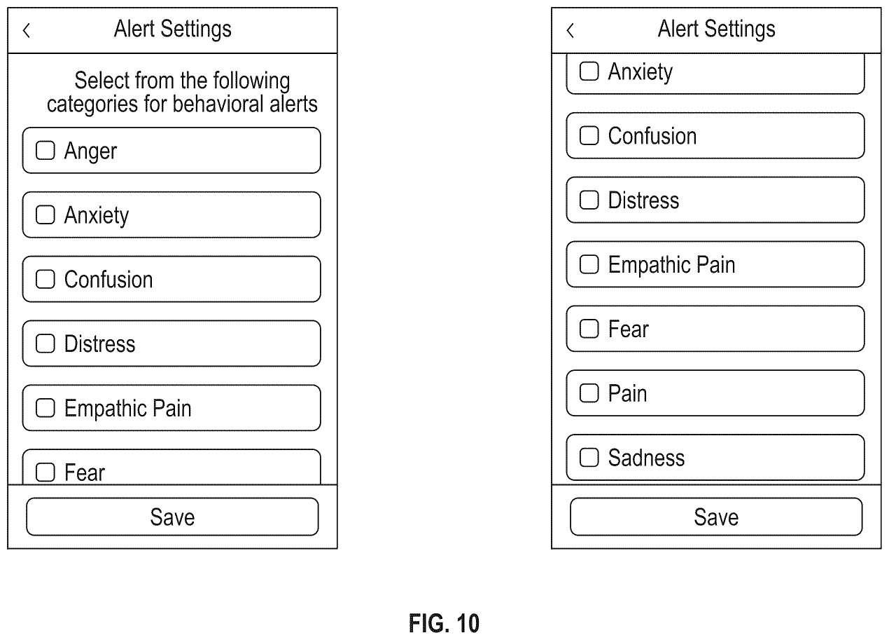

Additionally, as shown in the example user interface in FIGS. 8-10, the end user may optionally be prompted to enter additional user inputs such as reminders for calendar events or routine or habitual events of the end user (FIG. 8), emergency contact information for the end user (FIG. 9), and alert settings (FIG. 10). The alert settings are designed as behavioral alerts that present in simulated social interaction or conversation with the AI Companion that alert the facilitator of a potential issue or threat to the mental or physical well-being of the end user, such as anger, anxiety, confusion, distress, fear, sadness, etc. Such alert indicators as detailed in FIG. 10 may be particularly useful in monitoring socially isolated elderly end users at higher risk for dementia or Alzheimer's.

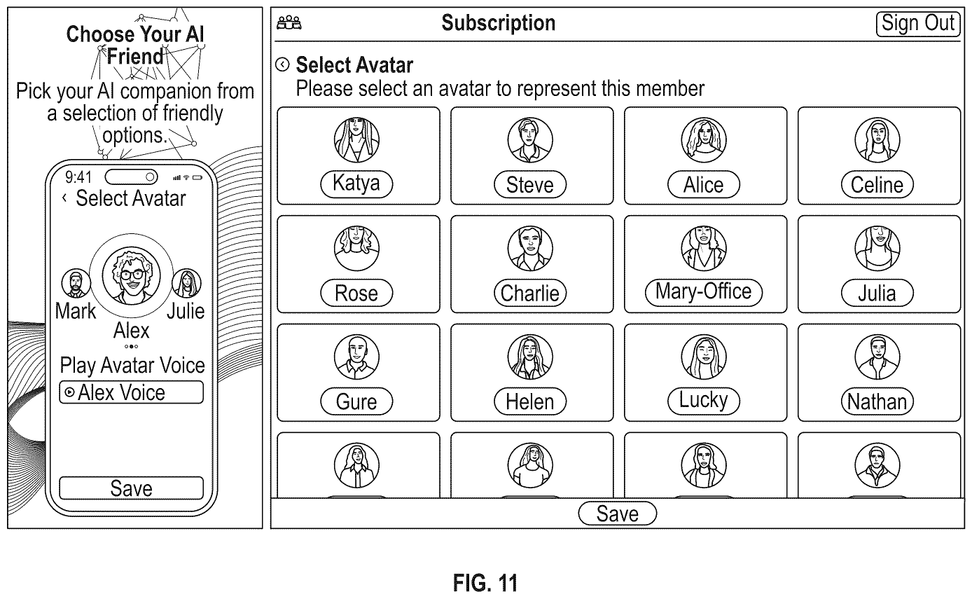

Still within step 201, the end user selects the visual appearance and auditory voice characteristics of the avatar for his/her AI companion, as shown in FIG. 11. In one example embodiment, the user interface avatars are built using commercially available technology and avatar services from the Tavus.io. In another example embodiment, the user interface avatars are built using commercially available technology and avatar services from the Microsoft Azure platform.

Once all end user inputs have been received by the computing device 30 and stored on the memory 34, at step 202 the processor 32 executes instructions to transmit the end user inputs from the computing device 30 to the system server platform 10 via the API 26.

At step 203, the system server platform 10 (or backend) compiles the end user profile and stores the end user profile (comprised of the respective end user inputs) in the storage database 18 and utilizes the end user profile to compile the knowledge base 20. In one example embodiment, the user profile and historic personalized chat history is stored as part of a knowledge base 20 and the storage database 18, e.g., part of an object-relational database management system (ORDMBS), that has relational capabilities and an object-oriented design such as PostgreSQL Oracle Database, IBM Db2.

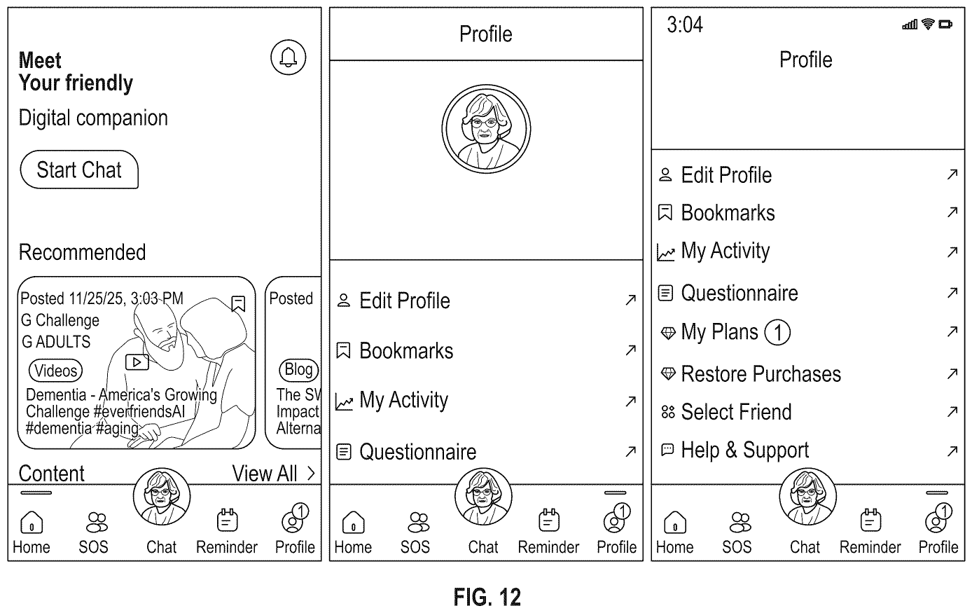

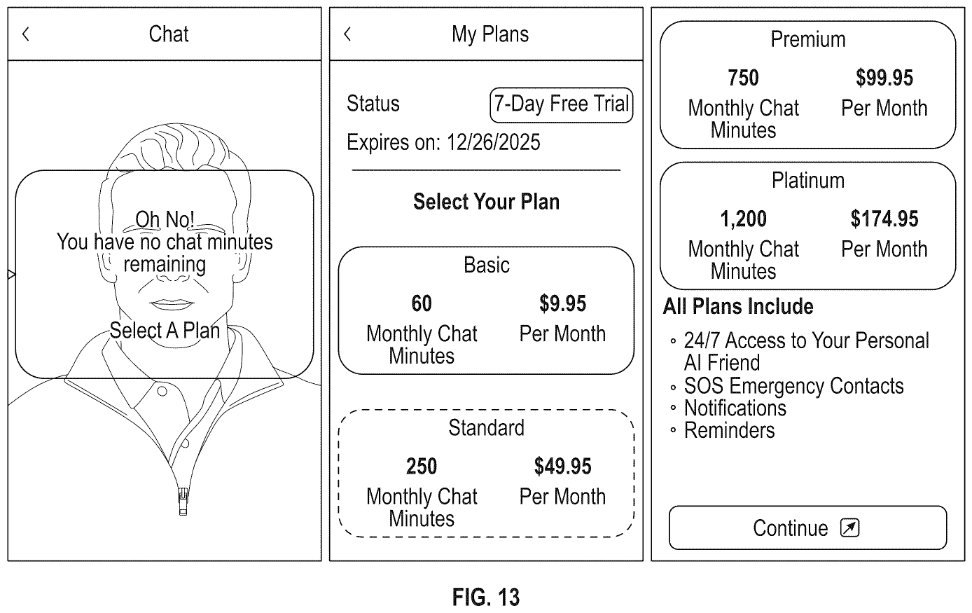

Once the end user profile is created and stored as part of the storage database 18 and the knowledge base 20, an end user dashboard interface is available to the end user as shown in FIG. 12. This interface allows the end user and any authorized facilitators to view a friends list and view evaluate interaction time or activity time with the system 11. From this interface the end user may view and edit the end user inputs such as behavioral alerts, avatar characteristics, reminders, emergency contacts, and responses to questionnaire compiled in FIGS. 5-11. From this interface the end user may also complete an interactive tutorial to explain application features. This dashboard interface also tracks the time remaining on any free trials or gifted subscriptions and prompts the end user to select a long-term subscription and payment plan for use of the system 11 when appropriate, i.e., computer program of software application via the computing device 30 as shown in FIG. 13.

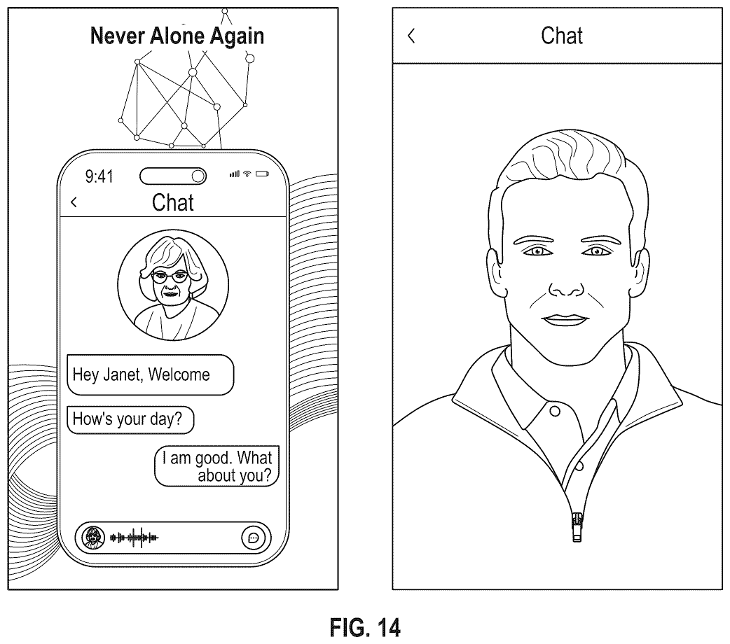

Once the user profile is compiled, and, optionally, the end user has completed the interactive tutorial and selected a subscription plan, at step 102 the end user may initiate a request to start a conversation with the AI companion embodied as the avatar having selected visual and voice characteristics selected by the end user. In this way, the end user submits a request to initiate a conversation with the AI companion via toggling the “Chat” or “Start Chat” button within the interface on the computing device 30 (FIG. 12). This request is received by the processor 32 and conveyed to the processor 12 via the API, which causes the application to initiate or open a conversation session on the interface shown in FIG. 14.

Once one of the example interfaces shown in FIG. 14 is opened, i.e., a conversation session, at step 103, the end user may provide an auditory or spoken conversational prompt to the computing device 30. This auditory or spoken conversation prompt is received by the processor 32 and transmitted, at step 104, to the processor 12 of the system server platform 10 (the backend) via the API. In some instances, end user may find it difficult to begin a conversation, just as in routine human interactions. As such, in one alternative, rather than an auditory or spoken conversation prompt, the end user may choose to select a pre-populated written conversation prompt. In such an example, upon selecting the system displayed, pre-populated conversation prompt, the pre-populated conversation prompt is received by the processor 32 and conveyed to transmitted, at step 104, to the processor 12 of the system server platform 10 (the backend) via the API.

At step 105, the spoken conversational or selected pre-populated conversational prompt is stored in the storage database 18 and the knowledge base 20.

At step 106, the spoken conversational prompt or pre-populated conversational prompt is evaluated by the learning language module 16, namely the NLU, NLP, and ASR modules, with reference to the knowledge base 20 and the storage database 18 such that the learning language module 16 formulates a natural language response to the respective conversational prompt.

At step 107, the response is transmitted by the processor 12 from the system server platform 10 to the processor 32 of the computing device 30 via the API and displayed, spoken, or played for the end user in the conversational session or interface shown in FIG. 13. In one example embodiment, the response is spoken by the AI companion having the selected visual and voice avatar characteristics selected by the end user at step 201.

Notably steps 103-107, i.e., receiving a conversation prompt from the end user via the computing device 30, transmitting the conversational prompt to from the computing device 30 to the system server platform 10 via the API 26, storing the conversational prompt in the knowledge base 20, evaluating the conversational prompt via the learning language model 16 with reference to the knowledge base 20 and the storage database 18 and formulating a response, transmitting the response from the system server platform 10 to the computing device 30 via the API 26 for delivery to the end user can be iteratively completed throughout a duration of the respective simulated social interaction or conversation, including any initial trial of the system 11 (as shown in FIG. 3).

As the relationship between the end user and the AI companion becomes more routine, or spans longer period of time, the system 11 generates a natural language conversational prompt with learning language module 16 with reference to the knowledge base 20, including but not limited to end user inputs.

More particularly, the system 11 may generate a natural language conversation prompt with the learning language module 16 with reference to the knowledge base, including end user inputs and store the natural language conversation prompt on the computer readable memory of the system server platform 10. The second processor 32 may then transmit the natural language conversation prompt to the API 26. The first processor 12 may receive the natural language conversation prompt from the API 26 and store the same on the computer readable memory 34 of the computing device. The first processor 12 may then send a notification to the end user, within the dashboard (as shown in FIG. 12) via the computing device regarding the receipt of the natural language conversation prompt and, upon end user request, deliver the natural language conversation prompt to the end user on the computing device via the Artificial Intelligence (AI) companion having the selected avatar characteristics.

In one example, the system 11 may review calendar dates which are encompassed in the end user inputs stored on the knowledge base 20 and utilize the learning language module 16 to generate a natural language conversation prompt inquiring with the end user about a calendar event. Checkpoints or system generated conversation prompts are designed to increase engagement between the end user and the AI companion.

It is envisioned that the system 11 and method 100 of the present disclosure will function as a responsive technology that brings comfort and meaningful empathetic conversations and emotional support to socially isolated individuals, particularly elderly individuals experiencing loneliness, particularly those at risk for dementia and Alzheimer's disease. It is also envisioned that routine interaction with an AI companion of the present disclosure will also bring peace of mind and transparent real time information to facilitators (family members and caregivers) of end users.

With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method of facilitating a collaborative conversation with an Artificial Intelligence (AI) companion comprising the steps of:
receiving a request to initiate a conversation with the AI companion from the end user via a computing device;
receiving a conversational prompt from the end user via the computing device and transmitting the conversational prompt via an Application Programming Interface (API) to a system server platform having a computer readable memory;
storing the conversational prompt in a storage database and a knowledge base written on the computer readable memory of the system server platform;
evaluating the conversational prompt via a learning language module written on the computer readable memory of the system server platform with reference to the knowledge base;
formulating a natural language response to the conversational prompt via the learning language module; and
transmitting the natural language response from the learning language module on the system server platform via the API to the computing device for delivery to the end user via the Artificial Intelligence (AI) companion having a plurality of selected avatar characteristics.

2. The method of claim 1 further comprising the step of compiling an end user profile from a plurality of end user inputs, wherein the step of compiling an end user profile from the plurality of end user inputs further comprises the steps of:
receiving the end user inputs from the end user via the computing device;
transmitting the plurality of end user inputs from the computing device via an Application Programming Interface (API) to a system server platform; and
storing the end user inputs in the storage database and the knowledge base written on the computer readable memory of the system server platform.

3. The method of claim 2 wherein the plurality of end user inputs comprises bibliographic information of the end user and bibliographic information of a facilitator.

4. The method of claim 3 wherein the plurality of end user inputs further comprises responses to an introductory questionnaire about the end user.

5. The method of claim 4 wherein the plurality of end user inputs further comprises a plurality of selected avatar characteristics of the Artificial Intelligence (AI) companion.

6. The method of claim 5 wherein the plurality of end user inputs further comprises at least one of emergency contact information for the end user, alerts related to end user behavior, and reminders for habitual events of the end user.

7. The method of claim 6 wherein receiving a conversational prompt from the end user via the computing device further comprises opening a conversation session on the computing device.

8. The method of claim 7 wherein the conversational prompt is a spoken conversational prompt conveyed to the computing device by the end user in auditory form.

9. The method of claim 7 wherein the conversational prompt is a pre-populated written conversational prompt populated by the knowledge base and transmitted from the system server platform to the computing device via the API.

10. The method of claim 7 further comprising the steps of:
generating a natural language conversational prompt with the learning language module with reference to the knowledge base and the end user inputs;
transmitting the natural language conversational prompt via the API to the computing device, wherein the computing device has a computer readable device memory;
storing the natural language conversational prompt on the computer readable device memory of the computing device;
sending a notification to the end user via the computing device regarding the natural language conversational prompt; and
delivering the natural language conversational prompt to the end user on the computing device via the Artificial Intelligence (AI) companion having the selected avatar characteristics.

11. A system of facilitating a collaborative conversation with an Artificial Intelligence (AI) companion comprising:
a computing device having a device computer readable memory, a first processor, and a first set of computer readable instructions written on the device computer readable memory;
a system server platform having a server computer readable memory and a second processor, the system server platform comprising a learning language module, a storage database, a knowledge base, and a second set of computer readable instructions written on the server computer readable memory;
an Application Programming Interface (API) configured to facilitate communication between the computing device and the system server platform;
wherein the first set of computer readable instructions executed by the first processor includes:
receiving a request to initiate a conversation with the AI companion from the end user via the computing device;
opening a conversation session on the computing device;
receiving a conversational prompt from the end user via the computing device; and
transmitting the conversational prompt to the API;
wherein the second set of computer readable instructions executed by the second processor includes:
receiving the conversational prompt from the API;
storing the conversational prompt in the knowledge base;
evaluating the conversational prompt via the learning language module with reference to the knowledge base and the storage database;
formulating a natural language response to the conversational prompt via the learning language module; and
transmitting the natural language response to the API.

12. The system of claim 11 wherein:
The first set of computer readable instructions executed by the first processor further includes:
receiving the natural language response from the API;
delivering the natural language response to the end user on the computing device via Artificial Intelligence (AI) companion having a plurality of selected avatar characteristics.

13. The system of claim 12 wherein:
the first set of computer readable instructions executed by the first processor further comprises:
receiving a plurality of end user inputs from the end user via the computing device;
transmitting the plurality of end user inputs to the API; and
the second set of computer readable instructions executed by the second processor further comprises:
receiving the plurality of end user inputs from the API; and
storing the plurality of end user inputs in the storage database and in the knowledge base.

14. The system of claim 13 wherein the plurality of end user inputs comprises bibliographic information of the end user and bibliographic information of a facilitator.

15. The system of claim 14 wherein the plurality of end user inputs further comprises responses to an introductory questionnaire about the end user.

16. The system of claim 15 wherein the plurality of end user inputs further comprises a plurality of selected avatar characteristics of the Artificial Intelligence (AI) companion of the end user.

17. The system of claim 16 wherein the plurality of end user inputs further comprises at least one of emergency contact information for the end user, alerts related to end user behavior, and reminders for habitual events of the end user.

18. The system of claim 17 wherein the conversational prompt is a spoken conversational prompt conveyed to the computing device by the end user in auditory form.

19. The system of claim 17 wherein the conversational prompt is a pre-populated written conversational prompt populated by the knowledge base and transmitted from the system server platform to the computing device via the API.

20. The system of claim 17 wherein:
the second set of computer readable instructions executed by the second processor further comprises:
generating a natural language conversational prompt with the learning language module with reference to the knowledge base and the end user inputs;
transmitting the natural language conversational prompt to the API; and
the first set of computer readable instructions executed by the first processor further comprises:
receiving the natural language conversational prompt from the API;
storing the natural language conversational prompt on the device computer readable memory of the computing device;
sending a notification to the end user via the computing device regarding receipt the natural language conversational prompt; and
delivering the natural language conversational prompt to the end user on the computing device via the Artificial Intelligence (AI) companion having the selected avatar characteristics.
